(19) United States
(12) Patent Application Publication
(10) Pub. No.: US 2025/0184591 A1
(43) Pub. Date: Jun. 5, 2025

(54) METHOD AND DEVICE FOR PRODUCING AN IMAGE OF A BOTTOM OF A GLASS VESSEL

(71) Applicants: Pedro Eid, Indian Rocks Beach, FL (US); Nikolas Estner, München (DE); Marcus Janik, München (DE)

(72) Inventors: Pedro Eid, Indian Rocks Beach, FL (US); Nikolas Estner, München (DE); Marcus Janik, München (DE)

(73) Assignee: Emhart Glass SA, Steinhausen (CH)

(21) Appl. No.: 19/051,529

(22) Filed: Feb. 12, 2025

Related U.S. Application Data
(63) Continuation of application No. PCT/EP2023/071232, filed on Aug. 1, 2023.

(30) Foreign Application Priority Data
Sep. 12, 2022 (DE) 102022123099.6

(51) Int. Cl. H04N 23/56; G06T 3/4038

(52) U.S. Cl. CPC H04N 23/56; G06T 3/4038

(57) ABSTRACT

A method and a device for producing an image of a bottom of a glass vessel having an axis use a matrix camera having pixels arranged in a plurality of rows and a plurality of columns. A series of individual photographs of strip-shaped regions of the bottom is captured by means of the matrix camera; mutually adjacent individual photographs partly overlap. A light source is used to transmit light through the bottom of the glass vessel during an individual photograph. Between different individual photographs, the glass vessel is rotated about its axis relative to the matrix camera. A digital image of the bottom of the glass vessel is composed from the series of individual photographs, the individual photographs being arranged at an angle relative to each other.

### CROSS-REFERENCE TO RELATED PATENT APPLICATIONS

This patent application is a Continuation of co-pending PCT Patent Application No. PCT/EP2023/071232, filed Aug. 1, 2023, which claims priority to German Patent Application No. 102022123099.6, filed Sep. 12, 2022, the entire teachings and disclosure of which are incorporated herein by reference thereto.

### FIELD OF THE INVENTION

The method and the device relate to the inspection of glass vessels, which have a bottom and an axis. However, the glass vessels do not have to be rotationally symmetrical.

In particular during the industrial production of glass vessels, defects such as flaws, cracks, inclusions of paint, foreign material or air may occur in the bottom of the vessels, albeit to a small extent. If such defects are detected in time, the defective vessels can be removed from the manufacturing process.

EP 2 434 276 B1, for example, discloses an inspection method for examining transparent or translucent vessels for defects such as cracks, fissures, bubbles or the like. The vessels are continuously conveyed by a conveyor device in a conveying direction. Each vessel passes through an inspection station in which a non-contact inspection of at least one selected vessel area of each vessel takes place.

In practice, difficulties arise in particular when a bottom of a vessel is to be inspected while the vessel is standing with its bottom on a supporting element, such as a storage area.

The object of the invention is to demonstrate a way in which a bottom of a glass vessel can be inspected in an improved manner.

This object is solved independently by a method according to claim 1 or by a device according to claim 10. Advantageous further developments are the subject of the dependent claims.

In a first aspect of the invention, a method for generating an image of the bottom of a glass vessel having an axis is provided. The axis of the glass vessel is typically essentially at a right angle above the bottom of the glass vessel, but the bottom may have a curvature and the glass vessel need not be rotationally symmetrical about the axis. In the context of the invention, the term “glass vessel” includes not only vessels that actually comprise glass but also vessels that comprise transparent or at least translucent plastics.

The method uses a matrix camera with pixels arranged in a plurality of rows and a plurality of columns, i.e. in contrast to previously used line scan cameras, a camera with an areal range of shot. It can be a CCD camera or a CMOS camera, for example a so-called high-speed camera.

This matrix camera is used to take a series of individual photographs (frames) of strip-shaped regions of the bottom of the glass vessel. The strip-shaped regions can be rectangular, but can also have other shapes, such as square or elliptical. Neighboring individual photographs overlap in sections.

During a single photograph, the bottom of the glass vessel is screened by means of a light source arranged on the opposite side of the bottom of the glass vessel from the matrix camera. The light source may be a pulsed light source, which is preferably operated in synchronization with the capturing of the individual photographs by the matrix camera.

To allow the light from the light source to pass through the vessel bottom and into the optical entrance of the camera, a recess in the mentioned supporting element is advantageous. The light source is located accordingly below, the vessel above. The length of the recess should in this case be at least large enough to extend from the center of the vessel bottom to beyond the edge of the vessel. However, it has proven to be advantageous if the length of the recess is greater than the entire diameter of the vessel, so that the illuminated photograph strip covers the entire bottom surface. The width of the recess should be chosen so that the vessel cannot fall through it and is still securely positioned on at least one side, but preferably on both sides, of the recess.

Between each individual photograph, the glass vessel is rotated around its axis relative to the matrix camera. Finally, a digital photograph of the glass vessel's bottom is composed from the series of individual photographs, with the individual photographs being arranged at an angle relative to each other.

During rotation, the axis of rotation may also shift relative to the vessel axis, so that the individual photographs not only show the intended angle of rotation compared to the previous photograph, but the vessel may also be shifted in the X and Y direction in the plane in the photograph. When combining the individual photographs, it may therefore be necessary to take into account a translational change in addition to the rotational change.

The rotation and displacement of the vessels from one photograph to another must not be so great that there is no overlap in the photograph area. It has proven to be advantageous to have a certain overlap, for example 10% or up to 50% of the photograph area, in both photographs. This overlap allows the individual photographs to be ideally matched on the basis of features that can be seen simultaneously in the neighboring individual photographs.

The digital photograph can be composed either while the series of individual photographs is being created or after the entire series of individual photographs has been taken.

A series of individual photographs (frames) consists of at least two individual photographs (frames), but preferably of at least three, at least four, at least five, at least ten or even at least fifteen, twenty, thirty or fifty individual photographs.

This method offers significant advantages over conventional methods in which the bottom of glass vessels is scanned using a line camera, i.e. a camera with only an individual photograph line, the photographs of which are placed next to each other in the form of a development without any relative rotation. In the conventional method, defects in the bottom of the glass vessel were sometimes extremely distorted or not displayed at all. In contrast, the method according to the invention allows a comparatively fast generation of a photograph that is largely free of distortion and, above all, completely captures the bottom of the glass vessel, which can then be analyzed with respect to defects in the glass vessel either visually by a user and/or by machine using suitable photograph processing software.

The angular arrangement of the individual photographs relative to one another is preferably carried out as accurately as possible, in the same way as the areas of the bottom captured by the individual photographs are arranged at an angle to one another.

It is useful if the software used to assemble the digital photograph of the bottom of the glass vessel is set up to recognize special points in the individual photographs and to join the individual photographs together by superimposing the special points. Such special points can be, on the one hand, imperfections, for example, the already mentioned defects, cracks, color or air inclusions (bubbles). On the other hand, special points can be structures deliberately introduced into the bottom of the glass vessel, for example, text, grooves or markings. The software, for example, with the inclusion of a photograph capture module, can be set up to recognize such special points and to join the individual photographs together in a suitable manner, with the best possible matching of the special points.

The assembly of the digital photograph of the bottom of the glass vessel may include a rotation, a linear displacement and/or a stretching or compression of one or more individual photographs. These measures may, for example, be aimed at creating the best possible superimposition of determined special points. Artificial intelligence (AI) can be used to assemble the digital photograph of the bottom of the glass vessel, which, by means of suitable self-learning processes, enables the assembly of the digital photograph to be optimized.

It is advantageous if the digital photograph of the bottom of the glass vessel is assembled taking into account the relative rotation between the glass vessel and the matrix camera between each two individual photographs (frames). The magnitude of this relative rotation between the glass vessel and the matrix camera between each two individual photographs can be known, constant and/or predetermined by the rotational movement. If the magnitude of the predetermined or performed relative rotation is used as an input variable in the software used to assemble the digital photograph, this reduces the computing power and time required to assemble the digital photograph.

The magnitude of the actual relative rotation between the glass vessel and the matrix camera between each two individual photographs can be, for example, 1 to 15°, preferably 2 to 12°. However, amounts outside of this range are also conceivable. The following applies: the greater the angle of relative rotation between two individual photographs, the smaller the number of individual photographs required for a photograph (and correspondingly lower the computing power), but the lower the achievable resolution.

Preferably, the bottom of the glass vessel is placed on a supporting structure, in particular a light-permeable surface, optionally with at least one recess, during the capturing of the individual photographs. In this way, for example, the light source can be located below the supporting structure or base, while the camera looks down on the bottom of the glass vessel from above. If the bottom of the glass vessel is placed on a supporting structure, this has the advantage that the bottom of the glass vessel is always in the same plane during the capturing of the series of individual photographs. This makes it easier to focus the individual photographs and thus improves the resolution of the digital photograph of the bottom. However, another variant is also conceivable, in which a (particularly axially symmetrical) glass vessel with a horizontal axis is mounted on two horizontally lying, rotating rollers as a supporting structure.

It has proven advantageous when the area of the bottom of the glass vessel captured by an individual photograph has a length greater than the diameter of the glass vessel. This is because it allows the entire bottom of the glass vessel to be fully captured after the glass vessel has been rotated by less than 180°.

An alternative design could be a shot from the center of the vessel to the diameter in order to capture the entire bottom during a rotation of less than 360°.

It may be useful for the area of the bottom of the glass vessel covered by an individual photograph to have a width of 10% to 30% of the diameter of the glass vessel, preferably a width of 15% to 25% of the diameter of the glass vessel. Without the file size of individual photographs becoming too large, with a minimum width of 10% or 15% of the diameter, there is a sufficiently high probability that there are sufficient features in the overlap area of neighboring individual photographs to favor the assembly of the individual photographs.

In a second aspect, the invention relates to a device for generating a photograph of a bottom of a glass vessel having an axis. The device comprises a matrix camera, the pixels of which are arranged in a plurality of rows and a plurality of columns, as well as a supporting structure for supporting the glass vessel and a light source for transilluminating the bottom of the glass vessel, the light source being arranged on the side of the supporting structure opposite the matrix camera. The device also includes a drive for producing a rotation of the glass vessel held by the supporting structure relative to the matrix camera and a memory for storing a series of individual photographs (frames) taken by means of the matrix camera of strip-shaped regions of the bottom of the glass vessel. Furthermore, the device comprises an evaluation unit which is configured to assemble a digital photograph of the bottom of the glass vessel from the series of individual photographs with the individual photographs arranged at an angle relative to one another. With the help of these measures, the advantages described in the introduction with regard to the first aspect arise.

The evaluation unit is preferably set up to recognize special points in the individual photographs and to join the individual photographs together by superimposing the special points. As mentioned, these special points can be defects (e.g. cracks or air inclusions) or specially introduced special points such as text, grooves or markings. The individual photographs are preferably joined in such a way that the special points in shape, size and orientation are superimposed as well as possible. To achieve this superimposition, the evaluation unit can comprise software that includes artificial intelligence (AI) and implements self-learning processes.

It is useful if the evaluation unit is set up to perform a rotation, a linear displacement and/or a stretching or compression of an individual photograph in order to compose the digital photograph of the bottom of the glass vessel. Each of these measures, or several of them, serve to optimize the superimposition of the individual photographs and the special points contained therein.

The light source used to illuminate the bottom of the glass vessel can be operated in a pulsed manner in order to enable particularly high light output during the individual photographs while reducing energy consumption. Preferably, the light source can be operated in a synchronized manner with the matrix camera in such a way that the pulsing of the light source is synchronized with the taking of the individual photographs.

It has proved advantageous if the supporting structure is set up to perform a relative rotation between the glass vessel and the matrix camera by an angle of 1 to 15°, preferably by an angle of 2 to 12°, between every two individual photographs. The smaller the amount of relative rotation, the higher the resolution that can be achieved with the digital photograph. As a supporting structure, for example, a translucent surface can be used on which the bottom of the glass vessel is placed during the taking of the individual photographs. Alternatively, the supporting structure can comprise a group of horizontally mounted rollers on which the glass vessel is horizontally mounted and is set in rotation by driving one of the rollers.

In a third aspect, the invention relates to a computer program product which, when run on a computer, is set up to assemble a digital photograph of the bottom of the glass vessel from a series of individual photographs (frames) of a bottom of a glass vessel with the individual photographs arranged at an angle relative to one another. The computer can be part of the evaluation unit of the device. The computer program product can comprise a photograph evaluation module configured to recognize special points of the bottom in the individual photographs, and/or the computer program product can comprise an artificial intelligence (AI) configured to optimize the overlaying of the individual photographs. Preferably, the computer program product is set up to optimize the overlaying of the individual photographs to compose the digital photograph with regard to the special locations recognized in the individual photographs.

### BRIEF DESCRIPTION OF THE DRAWINGS

Elements or features described in connection with one of the aspects (method, device or computer program product) can, individually or in combination, also be realized in one of the other two aspects in the context of the invention. In the following, the invention is further explained by means of an embodiment with reference to the Figures.

FIG. 1 shows a schematic top view of a device for inspecting vessels.

FIG. 2 shows a schematic sectional view of a device for generating a photograph of the vessel bottom according to an embodiment, wherein the section in FIG. 1 is indicated by I-I.

FIG. 3 shows a schematic representation of several individual photographs (frames) of the bottom of the glass vessel.

FIG. 4 shows a schematic representation of a composite photograph of the bottom of the glass vessel.

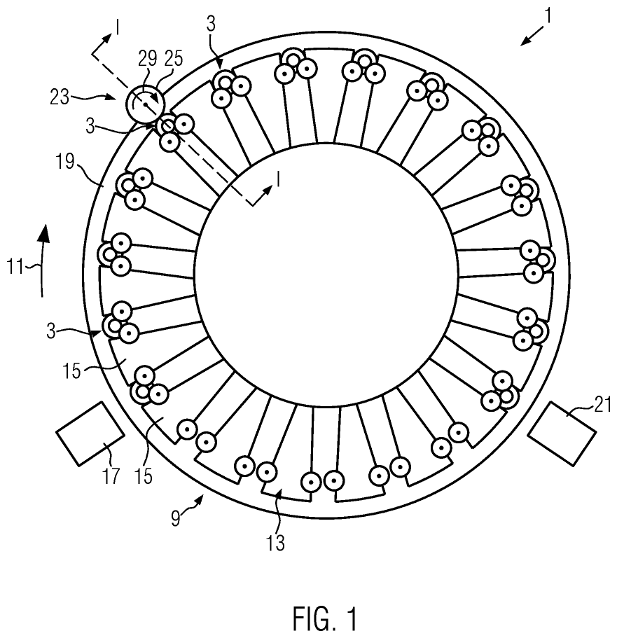

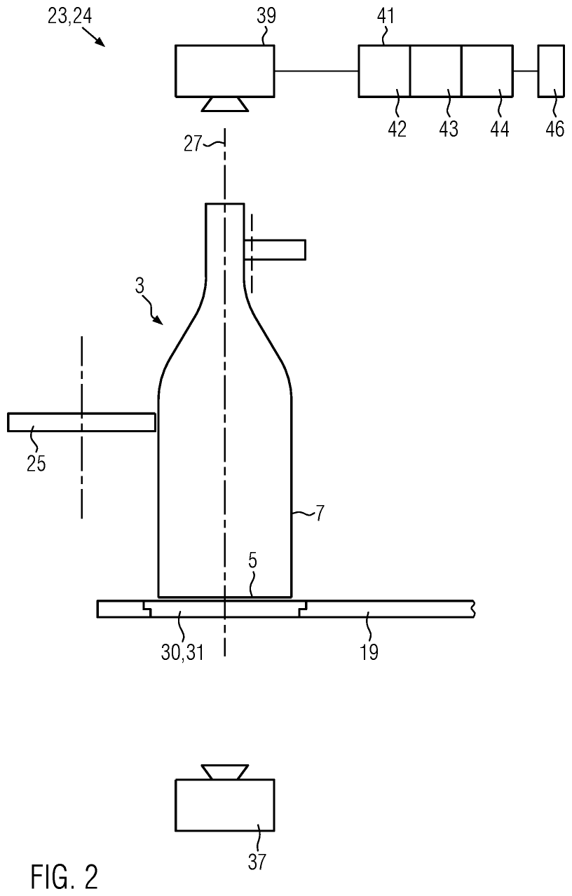

FIG. 1 shows a schematic top view of a device 1 for inspecting vessels 3. As shown in FIG. 2, the vessels 3 are, for example, glass bottles with a bottom 5 and a side wall 7. Alternatively, the vessels 3 may be, for example, other types of packaging glass, such as jam or preserving jars0.

### DETAILED DESCRIPTION OF THE INVENTION

As shown in FIG. 1, the device 1 comprises a transport device 9 for transporting the vessels 3 along a transport direction 11. In the illustrated embodiment, the transport device 9 has a star wheel 13 which transports the vessels 3 along a circular path. The star wheel 13 comprises holding elements 15, which are arranged one behind the other along a circumferential direction of the star wheel 13. The vessels 3 are transferred from a transfer station 17 to the star wheel 13 by being placed between adjacent holding elements 15 of the star wheel 13. The rotation of the star wheel 13 conveys the vessels 35 along the transport direction 11. During the conveying, the vessels 3 are pushed over a transport surface 19 of the transport device 9 by the holding elements 15 of the star wheel 13. The transport of the vessels 3 along the transport direction 11 is clocked. After the vessels 3 have been inspected in the device 1, they are removed from the transport device 9 by a removal station 21 located downstream of the transfer station 17 with respect to the transport direction 11.

Between the transfer station 17 and the removal station 21 in the direction of transportation 11, an inspection station 23 is provided, at which the bottom 5 of the vessel 3 present in the inspection station 23 is examined for flaws or defects. During the inspection of a vessel 3 by the inspection station 23, the star wheel 13 preferably stands still. Therefore, during this time in particular, there is no transportation of the vessel 3 along the transportation direction 11.

During the inspection of a vessel 3 in the inspection station 23, the vessel 3 is in an inspection position. In the inspection position, the vessel 3 is in contact with a drive or a rotating device 25. In the inspection position, the vessel 3 is rotated by the rotating device 25 about an axis 27 of the vessel (see FIG. 2) along a direction of rotation 29.

FIG. 2 shows a sectional view along the section indicated in FIG. 1 with I-I in the area of the inspection station 23. A device 24 for generating a photograph of the bottom 5 of the glass vessel 3 is arranged at the inspection station 23. The device 24 or the most important components of this device are shown in FIG. 2.

The vessel 3 shown in FIG. 2 is in the inspection position. In the inspection position, the vessel 3 stands with its bottom 5 on a supporting structure 30. In the embodiment shown, the supporting structure 30 is inserted into an accommodation of the transport surface 19. According to embodiments, the supporting structure 30 can be exchangeably inserted into the transport surface 19. Alternatively, the supporting structure 30 can be formed integrally with the transport surface 19. The transport surface 19 and the supporting structure 30 can have upper surfaces that are flush with one another, so that the bottle 3 can be pushed by the star wheel 13 from the transport surface 19 onto the supporting device 30. As an alternative to the embodiment shown, the rotating device 25 can be a drive configured to generate a rotation of the carrying structure 30 about the axis 27 of the vessel 3.

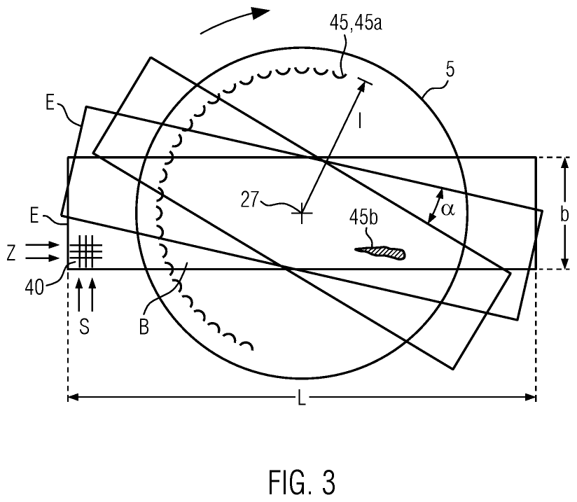

A matrix camera 39 is arranged above the supporting structure with its line of sight pointing vertically downwards. The axis 27 of the vessel 7 is essentially centered with respect to the line of sight of the matrix camera 39, which is directed from above through the opening of the vessel 7 onto the bottom 5 thereof. The matrix camera 39 is characterized by the fact that its photograph points (pixels) 40 are arranged in a plurality of rows Z and a plurality of columns S, as shown in FIG. 3, i.e. on a surface (instead of just in a single row).

On the side of the supporting structure 30 opposite the matrix camera 39, i.e. in the illustrated embodiment below the supporting structure 30, a light source 37 is arranged. The light source 37 is used to illuminate the bottom 5 of the glass vessel. For this purpose, the supporting structure 30 can, for example, have a light-permeable base 31 so that the light emitted by the light source 37 can penetrate the bottom 5 of the vessel 3. In the supporting structure 30 or the light-permeable base 31 one or more recesses 31a can exist through which light can pass. The light source 37 may be a pulsed light source, for example a stroboscopic light source. In this case, the emission of its light pulses can be synchronized with the operation of the matrix camera 39, for example by means of a (not shown) control of the device 24.

On the camera side, an optic with an integrated beam splitter and two attached cameras 39 can be used in a variant. One of the cameras 39 is arranged axially, as shown in FIG. 2, while the other is attached to the side of the optics at 90°. The light source 37 is equipped with a linear polarizing filter, while the camera optics are equipped with a linear polarizing beam splitter. One camera 39 thus sees a bright photograph, while the other camera 39 normally sees nothing, because the polarizing filters are arranged in a crossed pattern. However, if there is a stress inclusion (defect) in the bottle bottom 5, the polarization plane is rotated and the second camera 39 sees the stress center as a bright spot. The two cameras 39 thus serve to provide normal base control and stress control. Alternatively, a station 23 with only one camera without polarization evaluation can also be used. It is possible to use photograph sensors with a polarizing filter in front of them.

FIG. 3 shows a schematic representation of several individual photographs (or frames) E taken by the matrix camera 39. Due to the orientation of the matrix camera 39 and the arrangement of its pixels 40 in several rows Z and columns S, each individual photograph A of a strip-shaped region B of the floor 5 of the glass vessel 3 consists. In FIG. 3, the captured area B of the bottom 5 is the intersection between the circular bottom 5 of the glass vessel 3 and the total area of the single shot E. Each single shot E covers a certain length L and a certain width b. The length L of the area B of the bottom 5 of the glass vessel 3 covered by a individual photograph E is greater than the diameter I of the glass vessel 3, while the area B of the bottom 5 of the glass vessel 3 covered by a individual photograph E has a width b of approximately 10% to 30% of the diameter I of the glass vessel 3.

While a series of individual photographs E is being generated from the bottom 5 of a glass vessel 3, the vessel 3 is rotated relative to itself about its axis 27 between individual photographs E. The relative rotation between two individual photographs E can be effected by an angle of, for example, 1° to 15°, preferably by an angle of 2° to 12°. The rotation through the angle α is generated by the rotating device 25.

The device 24 comprises an evaluation unit 41, which can be integrated into the matrix camera 39 or connected to the matrix camera 39. The evaluation unit 41 comprises a memory 42 for storing a series of individual photographs E and a computer 43 on which a computer program product 44 is installed. The evaluation unit 41, or more specifically the computer program product 44 installed on it, is configured to assemble a digital photograph of the bottom 5 from a series of individual photographs E of the glass vessel 3. FIG. 3 indicates how this can be done:

In the bottom 5 of the glass vessel 3, there are a plurality of special points 45. The special points 45 may be impressions 45a that have been deliberately made in the bottom 5, for example all the way around, or they may be unwanted imperfections 45b, for example a bubble or a crack. A photograph recognition module of the computer program product 44 is set up to recognize such imperfections 45 in the individual photographs E. The evaluation device 41 is then configured to manipulate the individual photographs E in such a way that an optimal superimposition of the special points 45 in the respective individual photographs E is achieved. The manipulation may comprise a rotation of the respective individual photographs E (for example, but not necessarily, about the axis 27 of the vessel 3), a translation of the individual photographs E in their longitudinal and/or in their transverse direction and/or a stretching or compression of the respective individual photographs E.

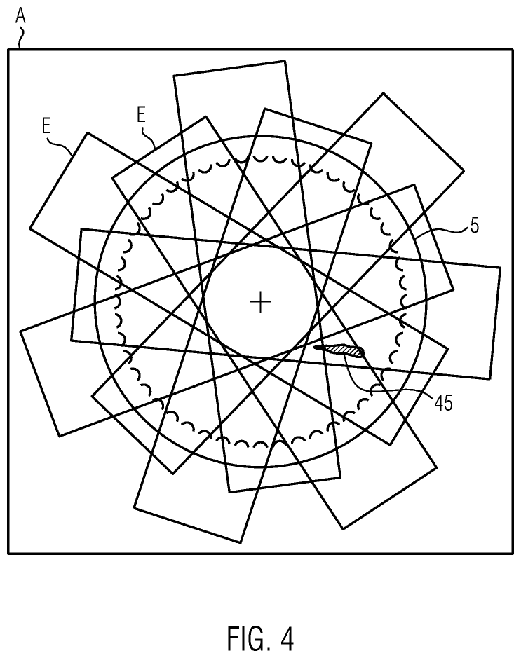

When all the individual photographs E of a series have been processed by the evaluation unit 41, it has generated a digital photograph A of the bottom 5 of the glass vessel 3, as shown in FIG. 4. The digital photograph A is composed of the respective individual photographs E, with the individual photographs E being arranged at an angle relative to one another. In this way, the result is not a “development” of the bottom 5 with corresponding distortions, but rather a distortion-free photograph of the bottom 5 of the glass vessel 3.

To facilitate the evaluation and assembly of the photograph A, the evaluation unit 41 can take into account the angle a through which the glass vessel 3 is rotated relative to the matrix camera 39 between two individual photographs E as an input variable. This input variable makes it easier for the evaluation unit 41 to assemble the digital photograph A, since the probability of the need for rotating the individual photographs E is reduced.

If the device 1, the inspection station 23 or the device 24 have a display 46 (see FIG. 2), the digital photograph A can be displayed there. Alternatively, the digital photograph A can be evaluated by machine. If defects 45b are detected, the corresponding glass vessel 3 can be ejected manually or automatically.

Based on the illustrated examples and the appended claims, the invention can be modified in various ways. One possibility, for example, is to capture and inspect (visually or by machine) individual photographs before or even without composing a digital photograph (A) of the bottom (5) of the glass vessel (3) from several photographs.

1. Method for producing an image of a bottom of a glass vessel having an axis,
wherein a matrix camera is provided with pixels arranged in a plurality of rows and a plurality of columns,
wherein a series of individual photographs of strip-shaped regions of the bottom of the glass vessel is captured by means of the matrix camera,
with neighboring individual photographs partly overlapping,
with the bottom of the glass vessel being illuminated by means of a light source arranged on the side of the bottom of the glass vessel opposite the matrix camera during an individual photograph,
wherein the glass vessel is rotated about its axis relative to the matrix camera between different individual photographs,
and wherein a digital photograph of the bottom of the glass vessel is composed from the series of individual photographs with the individual photographs being arranged at an angle relative to one another.

2. Method according to claim 1, wherein, for the purpose of assembling the digital photograph of the bottom of the glass vessel, a software is set up to recognize special points in the individual photographs and to join the individual photographs to one another by superimposing the special points.

3. Method according to claim 1, wherein a rotation, linear displacement and/or expansion or compression of an individual photograph is carried out to assemble the digital photograph of the bottom of the glass vessel.

4. Method according to claim 3, wherein the assembly of the digital photograph of the bottom of the glass vessel is carried out taking into account the relative rotation between glass vessel and matrix camera between each two individual photographs.

5. Method according to claim 1, wherein a relative rotation between the glass vessel and the matrix camera by an angle of 1 to 15°, preferably by an angle of 2 to 12°, takes place between each two individual photographs.

6. Method according to claim 1, wherein the bottom of the glass vessel stands on a supporting structure, in particular a light-permeable base, during the taking of the individual photographs.

7. Method according to claim 1, wherein the area of the bottom of the glass vessel covered by a single exposure has a length greater than a diameter of the glass vessel.

8. Method according to claim 1, wherein the area of the bottom of the glass vessel covered by the individual photographs has the axis of the glass vessel passing through it.

9. Method according to claim 7, wherein the area of the bottom of the glass vessel covered by an individual photograph has a width of 10% to 30% of the diameter of the glass vessel, preferably a width of 15% to 25% of the diameter of the glass vessel.

10. A device for producing an image of a bottom of a glass vessel having an axis, comprising a matrix camera having pixels arranged in a plurality of rows and a plurality of columns, a supporting structure for supporting the glass vessel, a light source for transmitting light through the bottom of the glass vessel, the light source being arranged on the side of the supporting structure opposite the matrix camera, a drive being provided for producing a rotation of the glass vessel received by the supporting structure relative to the matrix camera, wherein a memory is provided for storing a series of individual photographs of strip-shaped regions of the bottom of the glass vessel, taken by means of the matrix camera, and wherein the device comprises an evaluation unit which is configured to assemble a digital photograph of the bottom of the glass vessel from the series of individual photographs with the individual photographs being arranged at an angle relative to one another.

11. Device according to claim 10, wherein the evaluation unit is set up to recognize special points in the individual photographs and to join the individual photographs to one another by superimposing the special points.

12. Device according to claim 10, wherein the evaluation unit is configured to perform a rotation, linear displacement and/or a stretching or compression of an individual photograph for the purpose of assembling the digital photograph of the bottom of the glass vessel.

13. Device according to claim 10, wherein the light source is operable in a pulsed manner, preferably with the light source being operable in a synchronized manner with the taking of the individual photographs by the matrix camera.

14. Device according to claim 10, wherein the supporting structure is configured to perform a relative rotation between the glass vessel and the matrix camera by an angle of 1 to 15°, preferably by an angle of 2 to 12°, between every two individual photographs.

15. A computer program product which, when run on a computer, is configured to assemble a digital photograph of the bottom of a glass vessel from a series of individual photographs of the bottom of the glass vessel, with the individual photographs being arranged at an angle relative to one another.
